(19) United States
(12) Patent Application Publication
(10) Pub. No.: US 2005/0178411 A1
(43) Pub. Date: Aug. 18, 2005

(54) Cleaning device for kitchen ventilator

(76) Inventor: Chang Yuan Fu, Feng Yuan City (TW)

Correspondence Address: CHARLES E. BAXLEY, ESQ., 90 JOHN STREET, THIRD FLOOR, NEW YORK, NY, 10038, US

(21) Appl. No.: 10/781,540

(22) Filed: Feb. 17, 2004

(51) Int. Cl. B08B 3/02

(52) U.S. Cl. 134/107; 134/115 R; 134/166 R; 134/169 R; 134/116; 134/113

(57) ABSTRACT

A cleaning device for kitchen ventilator has a heating apparatus defined inside of a water tank of spray pump device, the heating apparatus serves to heat up the water inside of the water tank into hot water or vapor and the hot water or vapor are then sprayed on the fan blades, so as to dissolve the oil dirt of thereon, by such arrangements, the kitchen ventilator can be cleaned in a more effective way with small consumption of water.

### BACKGROUND OF THE INVENTION

1. Field of the Invention

The present invention relates to a cleaning device for kitchen ventilator, and more particularly to a cleaning device for kitchen ventilator that can produce hot water or vapor for cleaning the fan blades of the ventilator, and by this way, the ventilator of can be cleaned in a more effective way with small water consumption.

2. Description of the Prior Arts

A conventional cleaning device for kitchen ventilator normally has a water tank of a spray pump device disposed inside of the ventilator, inside of the water tank is filled with water or detergent, a pump is employed to transport the water or detergent to a spray nozzle on the internal side of the housing of the ventilator. By such arrangements the spray nozzle is able to spray the water or detergent on the fan blades during the operation of the ventilator, so as to clean the oil dirt. This kind of cleaning device has been commonly used for a long period, however, it still has some disadvantages need to be improved follows:

Since this conventional cleaning device sprays the detergent or water directly on the fan blades of the ventilator, it is only able to clean the new oil dirt or the weak adhesive dirt and it has no ability of cleaning the dirt of strong adhesion.

The present invention has arisen to mitigate and/or obviate the afore-described disadvantages of the conventional cleaning device for kitchen ventilator.

### SUMMARY OF THE INVENTION

The primary object of the present invention is to provide a cleaning device for kitchen ventilator that is provided inside of a water tank of spray pump device with a heating apparatus, the heating apparatus is able to heat up the water inside of the water tank into hot water or vapor, and the hot water or vapor are sprayed on the fan blades so as to improve the efficiency of cleaning the ventilator.

The secondary object of the present invention is to provide a cleaning device for kitchen ventilator that is capable of dissolving the oil dirt on the fan blades of the ventilator with the hot water or vapor produced by itself.

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 is a cross sectional assembly view of a cleaning device for kitchen ventilator of the present invention;

FIG. 2 is a perspective view of the cleaning device for kitchen ventilator of the present invention;

FIG. 3 is an illustrative view of showing the cleaning device of the present invention is spraying water on the fan blades;

FIG. 4 is another cross sectional assembly view of a cleaning device for kitchen ventilator in accordance with another embodiment of the present invention.

### DETAILED DESCRIPTION OF THE PREFERRED EMBODIMENTS

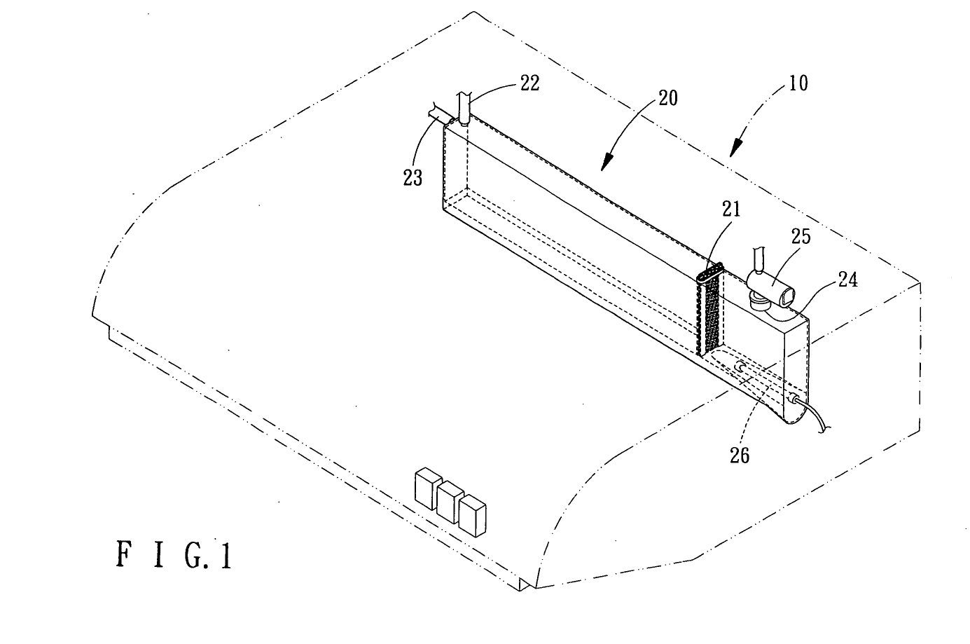

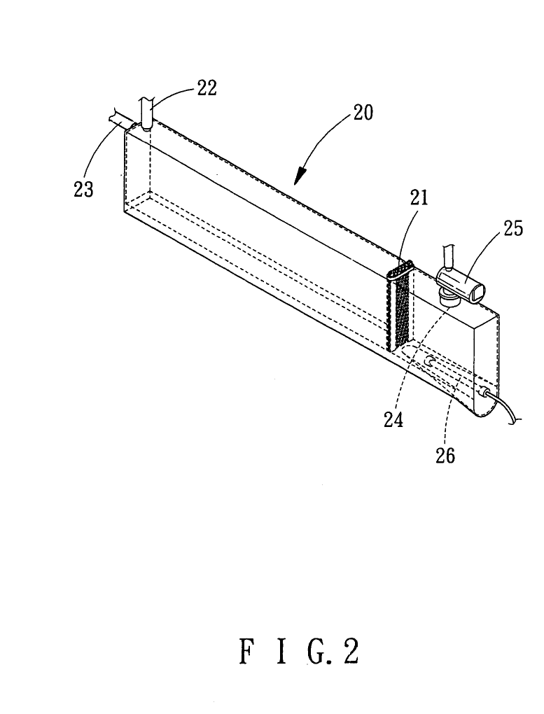

Referring to FIGS. 1-2, wherein a cleaning device for kitchen ventilator is shown and generally comprising: a water tank 20 of a spraying pump device is disposed inside of a kitchen ventilator 10 and interiorly provided with a filter member 21, at a side of the water tank 20 is further provided with a water inlet 22 and a water outlet 23 respectively.

The water tank 20 is further provided at another side with an outlet 24, on the outlet 24 a valve 25 is disposed, inside of the water tank 20 is defined with a heating apparatus 26.

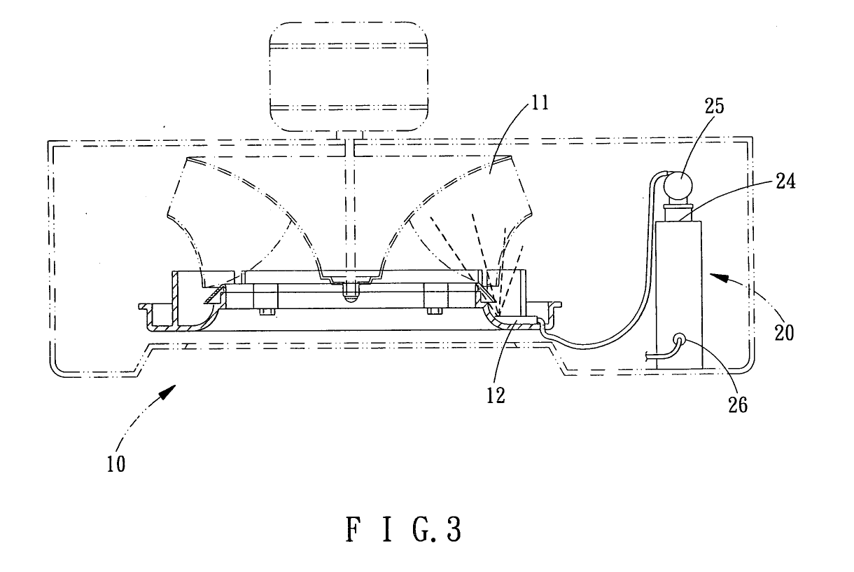

Referring to FIG. 3, wherein the heating apparatus 26 in the water tank 20 serves to heat up the water in the water tank 20 into hot water or vapor, and a valve 25 on the outlet 24 of the water tank 20 is employed to control the spray of the hot water or vapor so as to spray it onto the fan blades 11 of the ventilator 10 via a spray nozzle 12 for dissolving the oil dirt of thereon. By virtue of the centrifugal force generated from the rotation of the fan blades 11 of the ventilator 10, the hot water or vapor will flow inwardly from the outer edge of the fan blades 11, such that the ventilator of the present invention can be effectively cleaned with small water consumption.

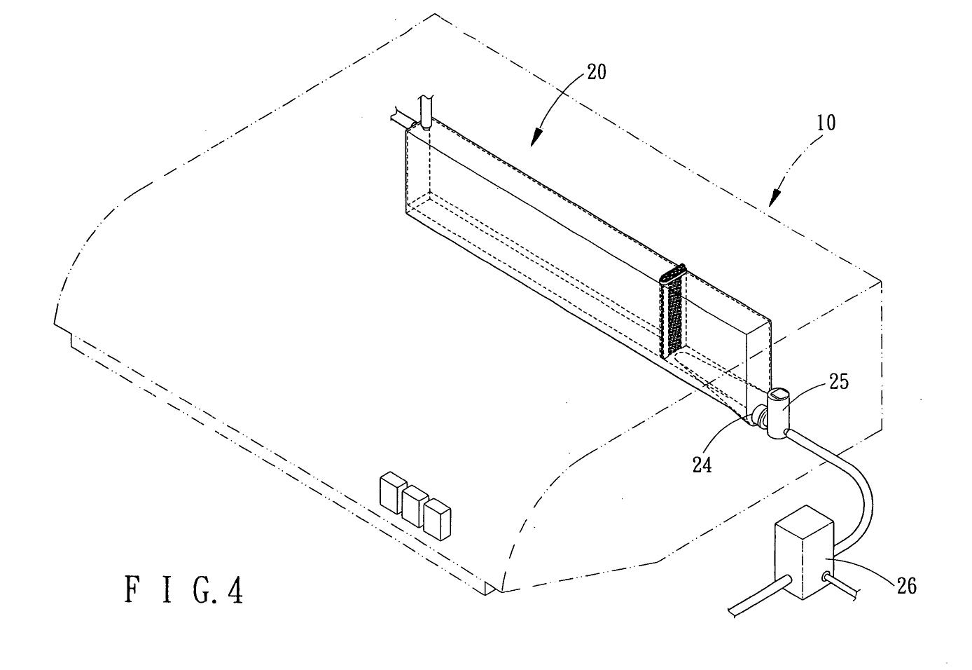

Referring to FIG. 4, wherein the heating apparatus 26 of the water tank 20 may be provided at the outer surface of the water tank 20 and the outlet 24 can be provided at an external side of the same, on the outlet 24 is alike defined with a valve 25. The water inside of the water tank 20 is connected with the heating device 26 by virtue of a pipe, and the heat water or vapor made by the heating device 26 is sprayed onto the fan blades 11 of the ventilator 10 so to clean the ventilator 10.

In addition, the heating apparatus 26 may be interiorly provided with a temperature controller, so as to control the heating apparatus 26 to heat the water into hot water or vapor. The valve 25 can be a mechanical valve or an electronic valve.

While we have shown and described various embodiments in accordance with the present invention, it should be clear to those skilled in the art that further embodiments may be made without departing from the scope of the present invention.

1. A cleaning device for kitchen ventilator having a water tank of a spray pump device disposed inside of the kitchen ventilator and having a spray nozzle connected with the water tank for spraying water on the fan blades of the ventilator;
the water tank provided with a heating apparatus for heating up the water inside of the water tank into hot water or vapor, and then spraying the hot water or vapor on the fan blades of the kitchen ventilator.

2. The cleaning device for kitchen ventilator as claimed in claim 1, wherein the water tank is provided at its top surface with an outlet, and a valve is disposed on the outlet, inside of the water tank is provided with the heating apparatus which serves for heating up the water into hot water or vapor, and then the hot water or vapor is sprayed to clean the kitchen ventilator under the control of the valve.

3. The cleaning device for kitchen ventilator as claimed in claim 1, wherein at a side of the water tank is defined with an outlet, and a valve is disposed on the outlet, at the outer surface of the water tank is defined with a heating apparatus which has a pipe for connecting with the water inside of the water tank, so as to heat up the water into hot water or vapor, and then the hot water or vapor is sprayed to clean the kitchen ventilator under the control of the valve.

4. The cleaning device for kitchen ventilator as claimed in claim 1, wherein the valve is a mechanical valve.

5. The cleaning device for kitchen ventilator as claimed in claim 1, wherein the valve is an electronic valve.

6. The cleaning device for kitchen ventilator as claimed in claims 2 or 3, wherein the heating apparatus is interiorly provided with a temperature controller for controlling it to heat up the water into hot water or vapor.
